(19) United States
(12) Patent Application Publication
(10) Pub. No.: US 2026/0251377 A1
(43) Pub. Date: Aug. 27, 2026

(54) A SYSTEM FOR DETECTING A FLOW RESTRICTION IN A DRAINAGE PIPE AND A LIQUID LEVEL SENSOR MODULE FOR SENSING THE LIQUID LEVEL IN A PIPE

(71) Applicant: CHARLES AUSTEN PUMPS LTD., Surrey (GB)

(72) Inventors: Andrew GREEN, Surrey (GB); Thomas PULLEN-WRIGHT, Surrey (GB); William Eric SHEPHERD, Surrey (GB)

(21) Appl. No.: 19/489,679

(22) PCT Filed: Jun. 7, 2024
(86) PCT No.: PCT/GB2024/051477

§ 371 Date: Dec. 3, 2025

(30) Foreign Application Priority Data
Jun. 8, 2023 (GB) 2308535.0

(51) Int. Cl. F25D 21/14; F04B 49/02; G01F 23/26

(52) U.S. Cl. CPC F25D 21/14; F04B 49/02; G01F 23/26

(57) ABSTRACT

A system for detecting a flow restriction in a drainage pipe with two liquid level sensors (10) one on each side of an inlet (7) to output a liquid level signal. A controller C compares the signals indicates a restriction if the signals differ too much. A liquid level sensor module (8) for sensing the liquid level in a pipe, having a circular body (17) releasably retained and to sealed in a port (14). The body (17) supports a liquid level sensor (10) to sense the liquid level. The module may be in a T shape housing. A condensate drain pump system with a pipe manifold has an inlet duct (31) at the top connected to a condensate outlet O and leading to a transverse outlet duct (32) with a liquid level sensor (10) at one end and a pump P at the opposite end to pump out liquid when the sensed level is too high.

The present invention relates to a system for detecting a flow restriction in a drainage pipe and a liquid level sensor module for sensing the liquid level in a pipe.

In particular, the system has been designed in order to monitor the flow from condensate outlets from a number of refrigeration units, for example, of the type used in supermarkets where a number of refrigeration units are arranged adjacent to one another along a supermarket aisle. Whilst the system has been designed for this purpose, it can be applied to any drainage system in which a number of outlets flow into a common drain. For example, in offices or flats wherein a number of individual drains lean into a common outlet duct.

In condensate drains for refrigeration systems, deposits of algae will build up over time forming a biofilm. The flow rates are relatively low through the condensate outlet pipes such that the biofilm is not reliably flushed away by the natural flow. As such, the biofilm will build up over time until it eventually creates a blockage somewhere along the outlet pipework.

This causes a number of problems. Firstly, once the blockage is formed, none of the units feeding into the blocked pipework will be able to discharge and the water will flood out from beneath the refrigeration unit across the floor of the supermarket. This causes a safety hazard, for which the supermarket may be liable for any consequences. In addition, all of the refrigeration units attached to the blocked pipework could need to be switched off to prevent further flooding and allow the blockage to be cleared. It is not possible to determine the location of the blockage simply by the refrigeration unit which floods, as this may not necessarily be the one at which the blockage has occurred, it is simply the one which has discharged the most condensate since the blockage formed.

As far as we are aware, there is no current system designed to deal with this problem.

According to a first aspect of the present invention, there is a system according to claim 1.

The use of sensors to detect a flow restriction in a pipe allows for a build up of material within the pipe to be detected before the pipe is fully blocked. The present invention allows the problem to be recognised before this becomes a critical condition, this also allows remedial action to be taken without the need to turn off the refrigeration units.

In the broadest sense, there may be one inlet. This allows a blockage associated with that inlet to be detected. Preferably the pipe comprises multiple inlets along its length and the system comprises a plurality of sensors arranged between respective inlets. When the flooding occurs in the prior art, all of the refrigeration units that are associated with the blocked pipework could need to be turned off to avoid further flooding problems until the blockage is cleared. The location of the flow restriction can be determined as being the location between a pair of adjacent sensors. In practice, there will preferably be one sensor between each adjacent pair of inlets, as well as a respective sensor upstream and downstream of the endmost inlets. Alternatively, fewer sensors may be provided if a less accurate determination of the location of the restriction is required.

In practice, remedial action will take the form of either applying suction at the outlet end of the pipe or inserting a rod into the pipe at least as far as the detected position of the blockage in order to dislodge it. Applying suction at the outlet end is generally easier but may be less effective, particularly if the blockage is closer to the inlet end. It is therefore useful to know the position of the blockage in order to help determine the best remedial action. The blockage adjacent to the outlet end may be more easily cleared by suction at the outlet end while a blockage closer to the opposite end may not be dislodged by applying suction at the outlet end but can be dislodged by only inserting a rod a relatively short way along the pipe. One possibility is to apply suction at the outlet end and measure if there is still an appreciable difference between the two adjacent sensors which determined the original blockage. If so, the rod can be inserted to clear the blockage.

Any suitable type of level sensor may be used. It may, for example, be a float sensor or pressure sensor. However, in order to most effectively detect a flow restriction, a relatively high degree of precision is useful. As such, the sensor is preferably a capacitive sensor. The capacitive sensor may be externally mounted on the pipe. However, for improved precision, the sensors preferably have capacitive elements which are positioned, in use, to be within the liquid in the pipe system. This senses the capacitance of the liquid directly and is therefore more precise than an external sensor which is also influenced by the capacitance of the pipe material.

To provide good sensing efficiency, capacitive elements should extend vertically for a reasonable portion of the depth of the pipe in order to detect a change for most of the depth of the pipe. Preferably, the capacitive elements extend vertically for at least 60% of the inner diameter of the pipe and, more preferably will extend for at least 80% and most preferably 100% of the inner diameter of the pipe.

The capacitive elements are preferably on a printed circuit board. This provides for a cost effective and robust way of providing capacitive elements which also allows them to be easily mounted in a manner which provides an electrical connection to the capacitive elements. This allows the capacitive elements to be formed as a plurality of tracks on the printed circuit board, extending close to the edges of the board and which are in fluid contact with the liquid in the drain.

The sensors may be mounted directly in the flow path through the pipe. However, preferably, the pipe has a bore forming a flow path along its length and the sensors are in fluid communication with the liquid in the flow path and are offset from the bore. Providing the sensors in fluid communication with the liquid in the flow path provides more accurate level detection as set out above. Further, offsetting them from the bore, allows a rod to be inserted along the flow path to clear a blockage without causing damage to the sensors.

Preferably, each sensor is housed in a hollow T shape housing having a pipe inlet port and a pipe outlet port connected to upstream and downstream pipes, to define a flow path from the pipe inlet port to the pipe outlet port across the top of the T and a sensor port opening at the base of the T in fluid communication with the flow path to receive and retain a sensor.

This provides a simple way of implementing the system. The T shape housing can be a standard T piece. Pipes can be attached to this in the conventional way while the base of the T provides for a readily accessible port and accommodates the sensor. The sensors may be permanently mounted to the pipe in the sense that they cannot be removed without causing irreversible damage to the pipe. Preferably, however, the sensors are releasably mounted. For example, flexible clips may be provided to retain them in place. This allows easy removal for inspection and replacement/repair.

Each sensor may have its own separate power supply and wiring. However, preferably, the invention further comprises electrical connections between adjacent sensors outside of the pipe to provide power and the transmission of signals. This connection of the sensors in series minimises the amount of wiring required and also allows for a modular system. In practice, as many sensors as necessary may be attached to the pipe and each one can be connected to an adjacent sensor by a length of cable.

The present invention also extends to a condensate drainage system comprising the system according to the first aspect of the invention and a plurality of condensate outlets from appliances, each of the condensate outlets being connected with a respective inlet. This condensate drainage system may be provided with any of the preferred features as set out above.

According to a second aspect of the invention, there is a liquid level sensor module according to claim 11.

This module has been particularly designed for use in the system according to the first aspect of the invention. However, it can also be used more broadly in any situation which requires a simple robust level sensor for detecting a liquid level within a horizontal or generally horizontal (slightly inclined at no more than 10°, preferably no more than 5°) pipe. Unusually it is designed to fit into and effectively plug a pipe port. It can be fitted directly into the end of the pipe itself or may be fitted into a simple or standard pipe fitting such as a T shaped housing and/or collar. The sensor may be inserted into the end of a pipe in order to sense the liquid level at the end of the pipe. Alternatively, it may be deployed in a lateral port in communication with the flow through the pipe, for example, using the T shape housing described above. The retaining mechanism allows the module to be easily removed for inspection, repair or replacement.

The second aspect of the present invention may be provided with preferred features of the first aspect, such as the capacitive sensor which may have capacitive elements which extend inwardly from the body so as to be positioned within the liquid in the pipe. It can also extend vertically to the extent set out above.

The capacitive sensor is preferably mounted, in use, in a vertical plane. This allows the sensor to have a high degree of sensitivity. An installer may be trained to insert the body in the correct orientation. The body of the sensor may be shaped or provided with markings to assist in the correct insertion orientation. Preferably the body has an exterior portion opposite to the circular portion which is provided with a pair of opposing flat surfaces. This allows the installer to grip the housing and insert the body into the port in the correct orientation. In view of the manner in which the capacitive sensor operates, there is no need for it to be exactly in a vertical plane in order to reliably detect the level.

The retaining mechanism is preferably configured such that it will only engage with the sensor module if it is inserted in the correct orientation. This provides a mechanism for preventing insertion in an incorrect orientation.

The body is a preferably a push fit into the pipe port. This allows for easy insertion

The body has an O-ring to seal with the pipe port. This provides a quick, reliable and robust seal.

Preferably, the module further comprises a collar fixed to the pipe to form the pipe port and the body of the sensor module being retained by the collar. The use of a collar to form the pipe port provides a well-defined orifice to receive the sensor module and may also be provided with additional features such as the retaining mechanism, for example a flexible clip.

The invention may also extend to a sensor assembly comprising a hollow T shape housing having a pipe inlet port and a pipe outlet port for connection, in use, to upstream and downstream pipes to define a flow path from the pipe inlet port to the pipe outlet port, a sensor port into the flow path to receive and retain a sensor module according to the second aspect of the present invention. This may include any of the preferred features of the first aspect of the invention.

For the above arrangement, preferably the flow path from the pipe inlet port to the pipe outlet port is across the top of the T and the sensor port is an opening at the base of the T. However this could be configured differently for a different application in small scale refrigeration as set out below.

The sensor element is preferably retained in a position in fluid communication with the flow path which does not obstruct the flow path.

The sensor assembly is primarily designed to be fitted in the space beneath refrigeration units which accommodates pipe work for the condensate flow. As such, the sensor module body is preferably positioned between respective horizontal planes which pass through the top and bottom of the outer diameter of the adjacent pipe. This allows the sensor module to be accommodated in the available space.

Alternatively or additionally, wiring between the sensor modules may be positioned between the respective horizontal planes which pass through the top and bottom of the outer diameter of the adjacent pipe. This allows the wiring to be accommodated in the available space.

In smaller scale refrigeration units such as ice machines and fridges (e.g., for drinks dispensing) or freezers (e.g., sliding top freezers) condensate is collected in an evaporation pan installed below the unit. This is a wide shallow pan from which the condensate will evaporate over time. The use of such a pan which may have standing water for a relatively long period of time, is not hygienic. Further there is nothing to stop the pan from flooding in the event of a prolonged flow of water, for example following a defrosting event. Furthermore, these systems are inefficient with high energy consumption required to evaporate the condensate using a heating element.

According to a third aspect of the invention, there is condensate drain pump system according to claim 27.

This solves the above problem of standing water in an evaporation pan. Instead of waiting for water to evaporate form an open pan, this arrangement collects water in the pipe manifold, monitors its level and pumps it out when a certain amount has collected. By using a drain pump system to evacuate condensate the heating element is no longer required, reducing energy consumption.

Preferably the sensor is provided on a sensor module according the second aspect of the invention inserted into the opposite end of the outlet duct. This provides another use for the sensor module. It is well suited in such an application as it is low cost, easy to install, accurate and robust.

The system may comprise a nozzle at the outlet end and connected to the pump. The nozzle can be sized to fit the pipe manifold at one end and the pump at the other providing a simple robust connection between the two.

The pipe manifold may be part of a more complex component, but it is preferably a T piece. This provides a housing which is a standard plumbing component which is low cost and is compatible with existing plumbing fixtures.

Examples of a system and liquid level sensor module in accordance with the present invention will now be described with reference to the accompanying drawings, in which:

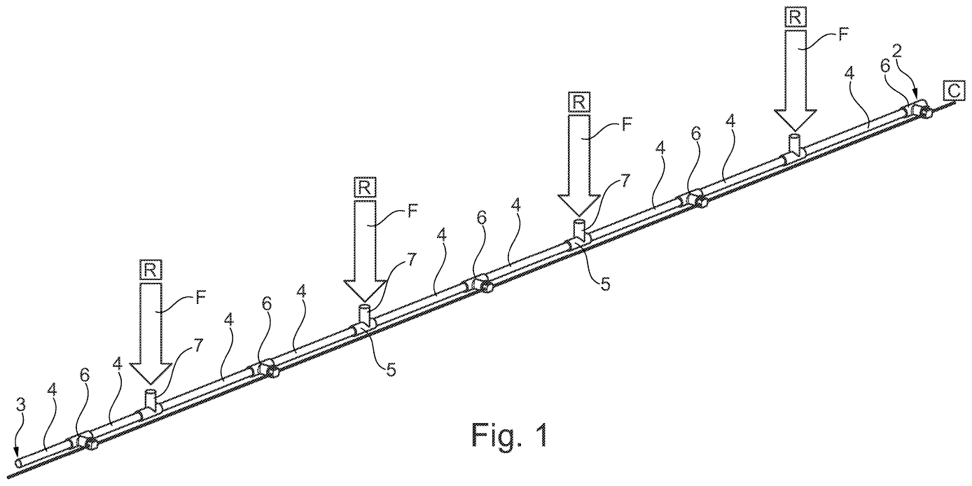

FIG. 1 is a perspective view of the system;

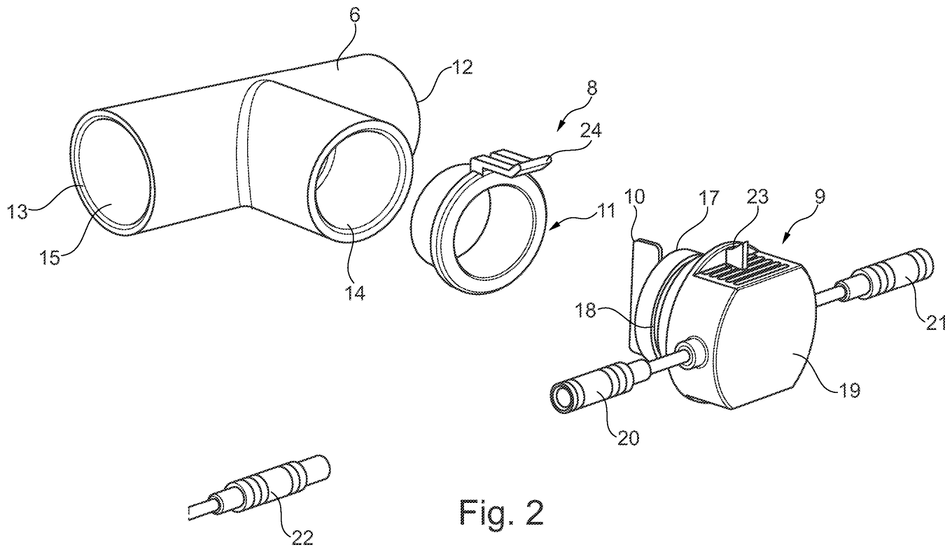

FIG. 2 is an exploded perspective view of a sensor module;

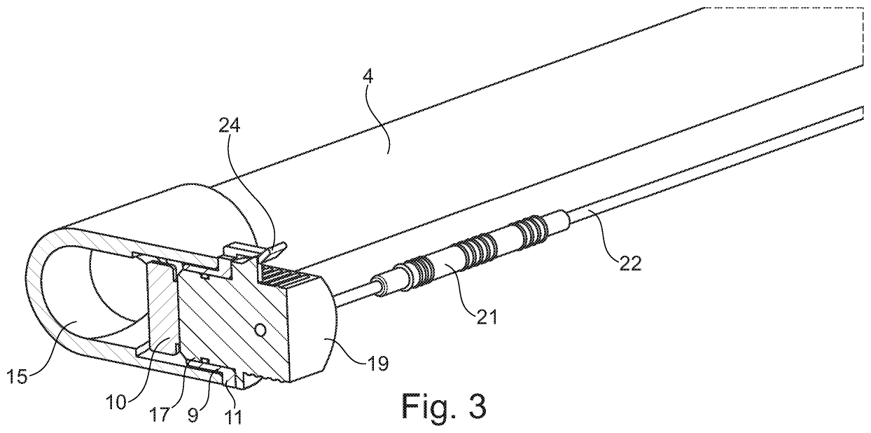

FIG. 3 is a partially sectioned perspective view of the sensor module of FIG. 2;

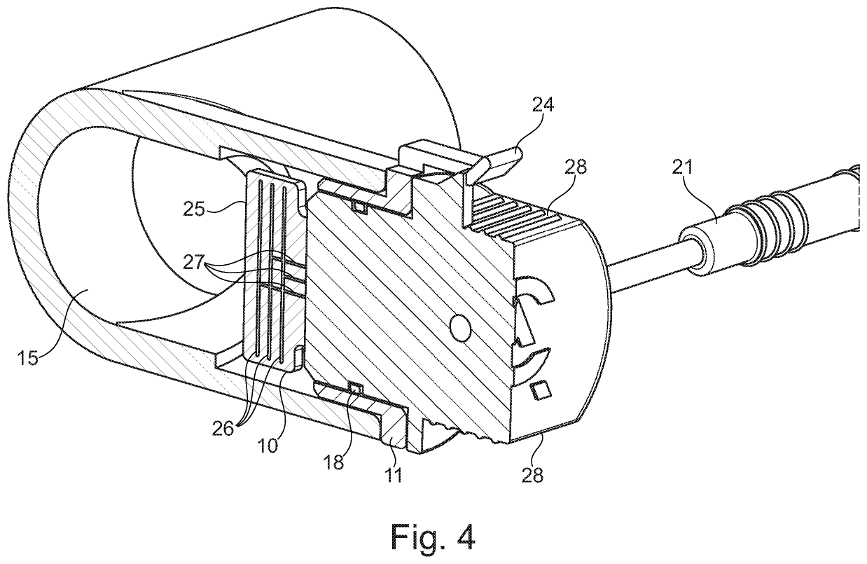

FIG. 4 is a view similar to FIG. 3 showing the sensor module and T shape housing in greater detail;

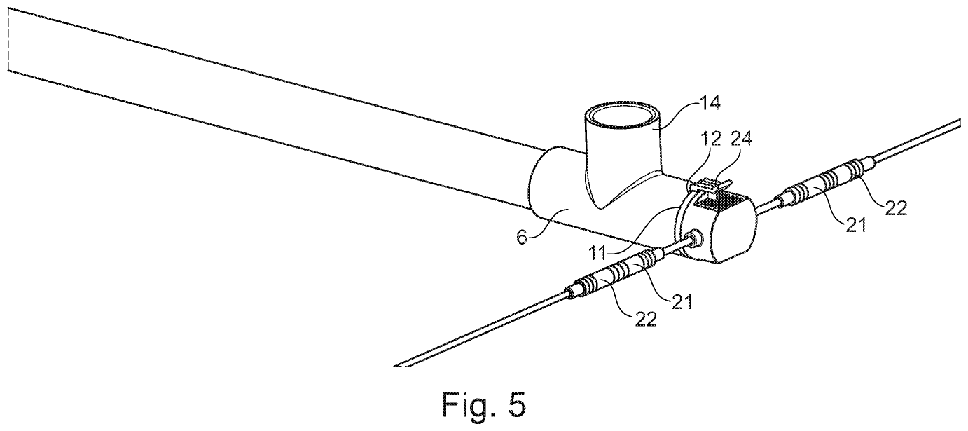

FIG. 5 is a perspective view showing a pipe system with a sensor module according to a second aspect of the invention in one end;

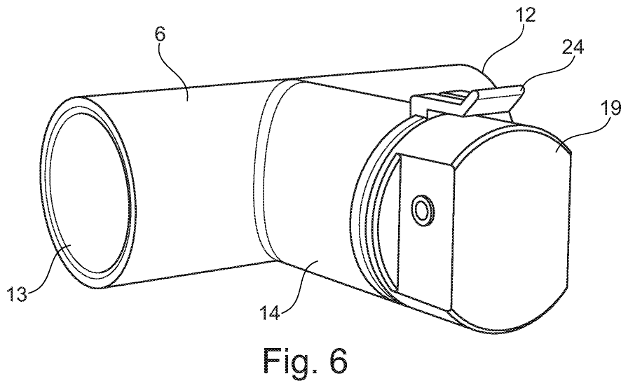

FIG. 6 is a perspective view of a second sensor module;

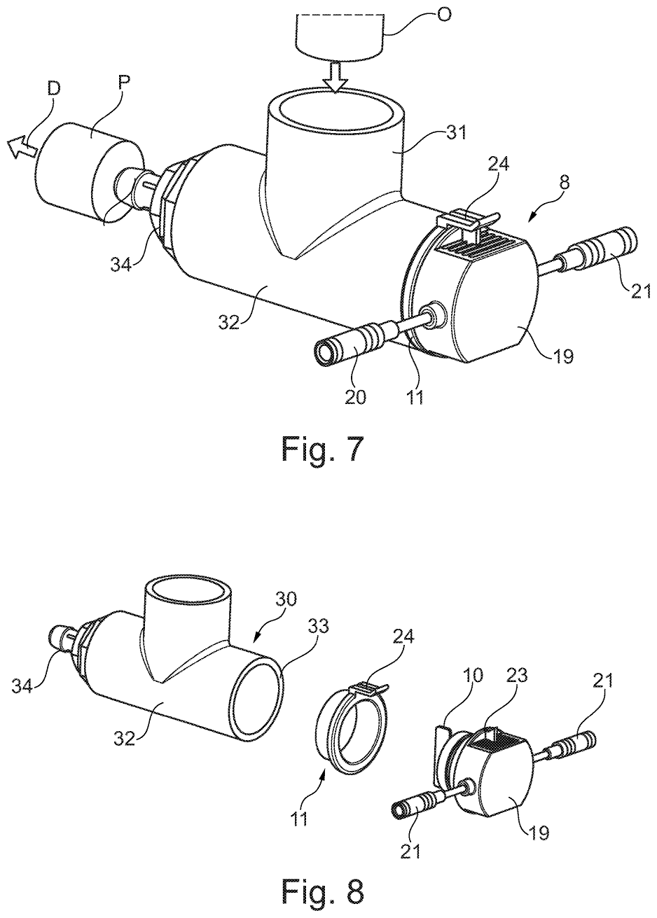

FIG. 7 is a perspective view of a condensate drain pump system; and

FIG. 8 is an exploded perspective view of FIG. 7.

The system shown in FIG. 1 is essentially a long drainage pipe 1 which receives condensate flows F from a plurality of refrigeration units R which are positioned above the pipe 1. Four refrigeration units R are shown in FIG. 1 (although any number may be present in practice).

The pipe 1 is generally horizontal and has a gentle downward incline from a cleaning port 2 at an upstream end to a drain port 3 at the opposite end.

In practice, the flows F from each refrigeration unit R are a slow trickle, and, although reasonably constant, may be somewhat intermittent. As a result, the flow pipe 1 has a trickle flow which increases towards the drain port 3 as more flows F flow to the pipe 1. This also becomes more constant caused by the averaging effect across the various individual flows F. The gentle flow rate of the flows is not sufficient to dislodge biofilm which builds up in the pipe 1.

As shown in FIG. 1, the pipe 1 is made up of a number of pipe segments 4. If the refrigeration units R are evenly spaced, the pipe segments 4 can be of even length. However, they can readily be adapted to accommodate uneven spacing. The pipe segments 4 are joined by a first 5 and second 6 T-pieces. The first T-pieces 5 connect adjacent pipe segments 4 and have a upwardly extending duct 7 which connects to the condensate outlet for the refrigeration unit R to receive the flow F. The connections between the first T-pieces 5 and pipe segments 4 and condensate outlet are solvent welded to ensure that they are watertight.

The second T-pieces 6 are positioned between the adjacent T-pieces 5. There are additional T-pieces 6 at the upstream end of the upstream T-piece 5 and the downstream end of the downstream T-piece 5. More T-pieces 6 may be used, for example where there is significant spacing between adjacent flows F. Alternatively, some of the T-pieces 6 may be omitted between adjacent flows F to provide a less costly, but also less accurate system. As with the first T-pieces 5, the second T-pieces 6 are solvent welded to the adjacent pipe segments 4.

The second T-pieces 6 are part of a sensor module 8 which now will be described with reference to FIGS. 2 and 3.

The sensor module 8 consists of a second T-piece 6, a sensor housing 9, incorporating the sensor element 10 and a collar 11.

The second T-piece 6 has an inlet port 12, an outlet port 13 and a sensor port 14. In identifying the inlet 12 and outlet 13 ports in FIG. 2, it is assumed that the flow direction is in the same sense as FIG. 1, namely from right to left. However, the sensor modules themselves are symmetrical about a median plane such that they could be used with the flow in the opposite direction.

As shown in FIG. 3, the manner in which the sensor housing 9 and sensor 10 are received within the sensor port 14 means that the sensor 10 is in fluid communication with the liquid through a bore 15 of the pipe segment 4. However, it is set back from the bore 15 of the pipe segment 4 such that it does not form a physical obstruction of the bore. This allows for a rod to be passed through the bore 15 in order to clear any blockages.

The sensor housing 9 has a number of functions. It houses the control and power electronics required for the sensor element 10. The housing 9 has a front portion 17 having a generally circular cross-section. This supports the sensor element 10 at the front end. This is also provided with an O-ring 18 which is designed to fit within the seal with the collar 11.

The collar 11 is an annular component which is welded into the port 14 to provide a well-defined port to receive the circular front portion 17 of the outer housing 9. The rear part 19 of the housing projects from collar 11 and is provided with a pair of electrical connections 20,21 which plug into the wire segments 22 which extend between adjacent modules 8.

The rear part 19 of the housing has a clip 23 which engages with a corresponding clip 24 on the collar 11 to retain the outer housing 9 in place.

The sensor housing 9 and the plug connections 20-22 extend laterally from the pipe 1 such that they take up little or no additional vertical space in comparison with the pipe segments 4. This allows the whole arrangement to be fitted into the space to accommodate the segments 4.

The nature of the sensor is shown in FIG. 4. As shown, this is a printed circuit board 25 which is printed with three capacitive electrodes 26 which extend vertically for a distance close to the full diameter of the pipe 4. The electrodes are connected by conductive tracks 27 to the front portion 17 housing 9.

The rear part 19 of the housing has a pair of opposing flat horizontal surfaces 28. These are gripped by an installer who then inserts the front portion 17 into the collar 11. The flats 28 also help to ensure that the sensor 10 is correctly orientated during insertion. Further, the clips 23,24 can only engage when the housing is correctly orientated providing a further safeguard against incorrect alignment.

In use, the condensate flows F flow into the pipe 1 and out through the drain port 3. Over time, a build up of biofilm or other matter will occur in the pipe leading to a flow restriction forming at some point along the pipe. As this reaches a critical size, the sensing element 10 downstream of the restriction will read a lower level and the sensing element 10 upstream of the restriction will read a higher level as the flow backs up behind the restriction.

This information is transmitted along the wires 22 to an optional controller C which compares the level readings from all of the sensors 10. Controller C has a communication system configured to interface and integrate with external systems, be that through Wi-Fi to a range of third party devices, or via an established Building Management System (BMS).

Once the output and adjacent pair of sensors detects a difference which exceeds a predetermined threshold, it will generate an alert in the form of an audible or visible alarm, and/or an error message sent to a monitoring device such as a mobile phone, tablet, or PC. This alerts an operator to the presence of a critical condition.

Based on the location of the blockage, the user may then elect either to apply suction at the outlet port 3 or to insert a rod into the pipe 1 at the opposite end to clear the blockage. As there is no need to stop further flooding, this operation can be carried out when the refrigeration units R continue to run. Once the clearing operation has been carried out, the sensors 10 should continue to detect a normal condition. In the event the blockage has not been adequately cleared, a further alert will be given allowing additional maintenance to be undertaken.

An alternative application of the sensor module 8 is shown in FIG. 5. This is inserted in a T piece 6. However, it is inserted in the port 12 rather than the lateral port 14, The collar 11 is inserted in this port to allow it to receive the module 8 as described above. The module 8 is in line with the bore 15 rather than being transverse to it as before. This allows the sensor 10 to measure the flow at the end of a pipe. In alternative arrangements, the T piece 6 can be replaced by a straight piece, or the collar 11 can be inserted into the end of the pipe.

An alternative to the housing 9 is shown in FIG. 6. This is the same in most respects as the previously described sensor module 9 except that the shape of the rear part 19 is different in that it now has flat sides rather than a flat top and bottom. The electrical leads 20, 21 are replaced by a pair of electric sockets 30, one of which is shown, and the other of which is provided on the opposite side of the rear part 19.

A condensate drain pump system is shown in FIGS. 7 and 8. This uses the sensor module 8 described with reference to FIGS. 2 to 5 (but could also use the module of FIG. 6). The same reference numerals are used to designate the same components.

The module is inserted into a pipe duct in the form of a T piece 30. This can be the same as the T piece 6 but is oriented differently. The T piece 30 has an upwardly facing inlet duct 31 connected, in use, to a condensate outlet O, The inlet duct 31 is horizontal and leads to a horizontal outlet duct 32 with a sensor port 33 at one end which received collar 11 and sensor module 8 as described above. The outlet duct 32 has a pipe nozzle 34 at the opposite end. This may be pushed into the end of the outlet duct 32 and sealed with an O ring or may be welded. The nozzle 34 allows a relatively large diameter pipe to be connected to a smaller inlet duct of the pipe P. This allows a conventional pump and piping to be readily accommodated.

When condensate has built up in the outlet duct 32, this is sensed by the sensor 10 causing the pump P to operate to pump the liquid out of the outlet duct 32 to the drain D. This system may also have a controller and communication system similar to the one described above to alert a user to abnormal conditions.

1. A condensate drainage system comprising a system for detecting a flow restriction in a drainage pipe, the system comprising a pipe with an inlet along its length and a downstream outlet,
at least two liquid level sensors one on each side of the inlet spaced along the pipe and arranged to output a signal corresponding to the liquid level adjacent to the respective sensor, and a controller receiving the output signals from the sensors, and being configured to compare signals from the sensors and to output a signal indicating a restriction between the sensors if their output signals differ by more than a predetermined amount;
the condensate drainage system further a plurality of condensate outlets from appliances, each of the condensate outlets being connected to a respective inlet.

2. A system according to claim 1, wherein the pipe comprises multiple inlets along its length and the system comprises a plurality of sensors arranged between respective inlets.

3. A system according to claim 1, wherein the sensors are capacitive sensors.

4. A system according to claim 3, wherein the sensors have capacitive elements which are positioned, in use, to be within the liquid in the pipe.

5. A system according to claim 4, wherein the capacitive elements extend vertically for at least 60% of the inner diameter of the pipe.

6. A system according to claim 3, wherein the capacitive elements are on a printed circuit board.

7. A system according to claim 1, wherein the pipe has a bore forming a flow path along its length and the sensors are in fluid communication with the liquid in the flow path and are offset from the bore.

8. A system according to claim 1, wherein each sensor is housed in a hollow T shape housing having a pipe inlet port and a pipe outlet port connected to upstream and downstream pipes, to define a flow path from the pipe inlet port to the pipe outlet port across the top of the T and a sensor port opening at the base of the T in fluid communication with the flow path to receive and retain a respective sensor.

9. A system according to claim 1, wherein the sensors are releasably retained with respect to the pipework.

10. A system according to claim 1, further comprising electrical connections between adjacent sensors outside of the pipe to provide power and the transmission of signals.

11. A liquid level sensor module for sensing the liquid level in a pipe, the sensor module comprising:
a body with a circular portion defining a central axis for insertion into a port in a pipe to sealingly engage with the pipe port,
a retaining mechanism to releasably retain the sensor module in the pipe port, and
a liquid level sensor element supported by the body and positioned to sense the liquid level in the pipe in a direction transverse to the central axis, when the sensor module is fitted in the pipe port.

12. A sensor module according to claim 11, wherein the sensor is a capacitive sensor.

13. A sensor module according to claim 12, wherein the capacitive sensor has capacitive elements which extend inwardly from the body so as to be positioned to be within the liquid in the pipe.

14. A sensor module according to claim 12, wherein the capacitive sensor is mounted, in use, in a vertical plane.

15. A sensor module according to claim 13, wherein the capacitive elements extend vertically for at least 60% of the inner diameter of the pipe.

16. A sensor module according to claim 11, wherein the body has an exterior portion opposite to the circular portion which is provided with a pair of opposing flat surfaces.

17.-20. (canceled)

21. A sensor assembly comprising a hollow T shape housing having a pipe inlet port and a pipe outlet port for connection, in use, to upstream and downstream pipes, to define a flow path from the pipe inlet port to the pipe outlet port, a sensor port into the flow path to receive and retain a sensor module according to claim 11.

22. A sensor assembly according to claim 21, wherein the flow path from the pipe inlet port to the pipe outlet port is across the top of the T and the sensor port is an opening at the base of the T.

23.-25. (canceled)

26. A condensate drain pump system, the system comprising:
a pump,
a T shape pipe manifold having an inlet duct at the top connectable to a condensate outlet and leading to a mid portion of a transverse outlet duct, the transverse outlet duct having an outlet at one end connected to the pump,
a sensor at the opposite end and the mid portion being in fluid communication with the inlet duct,
the sensor being configured to sense the liquid level in transverse the outlet duct and to activate the pump, to pump liquid out of the pipe manifold when the sensed level exceeds a predetermined level.

27. A system according to claim 26, wherein the sensor is provided as a sensor module according to claim 21 inserted into the opposite end of the outlet duct.

28. (canceled)

29. (canceled)
